(19) United States
(12) Patent Application Publication
(10) Pub. No.: US 2026/0155440 A1
(43) Pub. Date: Jun. 4, 2026

(54) ELECTROLYTE FOR LITHIUM-SULFUR BATTERY AND LITHIUM-SULFUR BATTERY INCLUDING THE SAME

(71) Applicant: LG ENERGY SOLUTION LTD., Seoul (KR)

(72) Inventors: Myeong-Seong KIM, Daejeon (KR); Ki-Hyun KIM, Daejeon (KR)

(21) Appl. No.: 19/122,209

(22) PCT Filed: Dec. 26, 2023
(86) PCT No.: PCT/KR2023/021619

§ 371 Date: Apr. 17, 2025

(30) Foreign Application Priority Data
Dec. 26, 2022 (KR) 10-2022-0185078

(51) Int. Cl. H01M 10/0567; H01M 4/02; H01M 4/133; H01M 4/134; H01M 4/136; H01M 4/36; H01M 4/38; H01M 4/58; H01M 4/587; H01M 10/052; H01M 10/0568; H01M 10/0569

(52) U.S. Cl. CPC H01M 10/0567; H01M 4/133; H01M 4/134; H01M 4/136; H01M 4/364; H01M 4/382; H01M 4/5815; H01M 4/587; H01M 10/0568; H01M 10/0569; H01M 2004/021; H01M 2004/027; H01M 2004/028; H01M 10/052

(57) ABSTRACT

An electrolyte for a lithium-sulfur battery according to aspects of the present disclosure includes an organic solvent; a lithium salt; and an additive, wherein the additive includes tantalum pentafluoride (TaF₅). According to certain aspects, the electrolyte can be provided as a part of a lithium-sulfur battery comprising: a positive electrode; a negative electrode; a separator between the positive electrode and the negative electrode; and the electrolyte. The electrolyte for the lithium-sulfur battery including tantalum pentafluoride can improve life characteristics of the lithium-sulfur battery.

### CROSS REFERENCE TO RELATED APPLICATIONS

The present application is a National Phase entry pursuant to 35 U.S.C. § 371 of International Application No. PCT/KR2023/021619, filed on Dec. 26, 2023, and claims the benefit of and priority to Korean Patent Application No. 10-2022-0185078 filed on Dec. 26, 2022 in the Republic of Korea, the disclosures of each of which are incorporated herein by reference in their entirety for all purposes as if fully set forth herein.

### TECHNICAL FIELD

Aspects of the present disclosure relate to a lithium-sulfur battery with improved life characteristics.

### BACKGROUND

As there is increasing attention paid to energy storage technology, with an extended range of applications as sources of energy for mobile phones, tablets, laptop computers, camcorders, electric vehicles (EVs) and hybrid electric vehicles (HEVs), more efforts are being made in the research and development of electrochemical devices. In this aspect, in the field of electrochemical devices, attention is directed to development of secondary batteries that can be recharged, such as lithium-sulfur batteries, and more recently, in the development of batteries, to improve capacity density and specific energy, research and development efforts are devoted to new electrode and battery designs.

Among electrochemical devices, lithium-sulfur (LiS) batteries are attracting attention as a next-generation secondary battery that can replace lithium ion batteries due to high energy density. Lithium sulfur is used as a positive electrode active material, and reduction reaction of sulfur and oxidation reaction of lithium metal occur in lithium-sulfur batteries during discharging, and in this instance, lithium polysulfide (e.g. Li₂S₂, Li₂S₄, Li₂S₆, Li₂S₈) of linear structure is produced from sulfur (S₈) of having a ring structure, with the lithium-sulfur batteries showing a gradual discharge voltage until polysulfide (PS) is completely reduced to LiS. However, the lithium polysulfide can react with electrolytes, causing side reactions, which can result in battery degradation.

Additionally, negative electrodes of lithium-sulfur batteries may use lithium metal, and life characteristics can decrease due to dendrite growth and porousization at lithium metal electrodes with increasing charge and discharge cycles.

Additionally, to achieve high energy density of lithium-sulfur batteries, it is often necessary to reduce the amount of electrolyte, but when the amount of electrolyte is reduced, the concentration of lithium polysulfide increases, which can accelerate side reaction with lithium metal electrodes, resulting in shorter battery life.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY

Aspects of the present disclosure are directed to providing an electrolyte for a lithium-sulfur battery for improving life characteristics of the lithium-sulfur battery.

Aspects of the present disclosure are further directed to providing a lithium-sulfur battery with high energy density and improved life characteristics.

According to an aspect of the present disclosure, in the interests of addressing the above described problem, there is provided an electrolyte for a lithium-sulfur battery or a lithium-sulfur battery according to any of the following embodiments.

The electrolyte for the lithium-sulfur battery according to a first embodiment includes an organic solvent; a lithium salt; and an additive, wherein the additive includes tantalum pentafluoride (TaF₅).

According to a second embodiment, the tantalum pentafluoride is included in an amount of 0.1 to 1 wt % based on a total weight of the electrolyte for the lithium-sulfur battery.

According to a third embodiment, the tantalum pentafluoride is included in an amount of 0.3 to 0.7 wt % based on a total weight of the electrolyte for the lithium-sulfur battery.

According to a fourth embodiment, the organic solvent includes an acyclic ether or a cyclic ether.

According to a fifth embodiment, the lithium salt includes at least one selected from the group consisting of LiFSI, LiTFSI, LiPF₆, LiClO₄, LiAsF₆, LiBF₄, LiSbF₆, LiAl0₄, LiAlCl₄, LiCF₃SO₃, LiC₄F₉SO₃, LiN(C₂F₅SO₃)₂, LiN(C₂F₅SO₂)₂, LiN(CF₃SO₂)₂, LiCl, LiI, and LiB(C₂O₄)₂.

According to a sixth embodiment, the additive includes at least one selected from the group consisting of lithium nitrate (LiNO₃) potassium nitrate (KNO₃), cesium nitrate (CsNO₃), magnesium nitrate (Mg(NO₃)₂), barium nitrate (Ba(NO₃)₂), potassium nitrite (KNO₂) and cesium nitrite (CsNO₂).

According to a seventh embodiment, the lithium-sulfur battery includes a positive electrode; a negative electrode; a separator between the positive electrode and the negative electrode; and an electrolyte, wherein the electrolyte includes any as defined in any one of the first to sixth embodiments, the positive electrode includes a sulfur-carbon composite as a positive electrode active material, and the negative electrode includes a lithium metal as a negative electrode active material.

According to an eighth embodiment, the sulfur-carbon composite includes a sulfur-based material supported on a porous carbon material, and the electrolyte for the lithium-sulfur battery is included in an amount of 300 wt % or less based on 100 wt % of the sulfur-based material.

According to a ninth embodiment, the sulfur-carbon composite includes a sulfur-based material supported on a porous carbon material, and the sulfur-based material is included in an amount of 60 wt % or more based on 100 wt % of the sulfur-carbon composite.

According to a tenth embodiment, the negative electrode includes a negative electrode active material layer and a protective layer on at least one surface of the negative electrode active material layer, and the protective layer includes LiF.

The electrolyte for the lithium-sulfur battery according to aspects of the present disclosure may improve the life characteristics of the lithium-sulfur battery and increase the energy density of the battery.

Aspects of the present disclosure may have many other effects, and these effects will be described in each embodiment, and with regard to effects that can be easily inferred by those skilled in the art, the corresponding description is omitted.

### BRIEF DESCRIPTION OF THE DRAWING

The accompanying drawing illustrates exemplary embodiments of the present disclosure and together with the foregoing detailed description, serve to provide a further understanding of the technical aspect of the present disclosure, and the scope of the present disclosure is not limited thereto. In the drawing, for clarity of description, the shape, size, scale or proportion of the elements may be exaggerated for emphasis.

FIG. 1 shows Coulombic efficiency and capacity vs cycle life in the Example and the Comparative Example described in the present disclosure.

### DETAILED DESCRIPTION

Hereinafter, aspects of the present disclosure will be described in detail with reference to the accompanying drawing. It should be understood that the terms or words used in the specification and the appended claims should not be construed as limited to general and dictionary meanings, but rather interpreted based on the meanings and concepts corresponding to the technical aspect of the present disclosure on the basis of the principle that the inventor is allowed to define terms appropriately for the best explanation.

Therefore, the embodiments described herein and illustrations shown in the drawings are provided to describe exemplary embodiments of the present disclosure, but are not intended to fully describe the technical aspect of the present disclosure, so it should be understood that a variety of other equivalents and variations could have been made thereto at the time the application was filed.

The term “comprise”, “include” or “have” when used in the present disclosure, specifies the presence of stated elements, but does not preclude the presence or addition of one or more other elements, unless the context clearly indicates otherwise.

The terms “about” and “substantially” as used herein are used in the sense of at, or nearly at, when given the manufacturing and material tolerances inherent in the stated circumstances, and are used to prevent the unscrupulous infringer from unfairly taking advantage of the present disclosure where exact or absolute FIGURES are stated as an aid to understanding the present disclosure.

In the present disclosure, A and/or B refers to either A or B or both.

Unless the context clearly indicates otherwise, temperature is indicated on the Celsius scale, and its unit is ° C.

Aspects of the present disclosure relate to an electrolyte for a lithium-sulfur battery and a lithium-sulfur battery including the electrolyte. The lithium-sulfur battery includes a sulfur-based material as a positive electrode active material. According to certain aspects of the present disclosure, the sulfur-based material includes at least one selected from the group consisting of sulfur and a sulfur compound, as described in more detail below.

A first aspect of the present disclosure relates to an electrolyte for a lithium-sulfur battery.

The electrolyte for the lithium-sulfur battery according to an aspect of the present disclosure includes an organic solvent; a lithium salt and an additive, and the additive includes tantalum pentafluoride (TaF₅). The addition of the tantalum pentafluoride to the electrolyte for the lithium-sulfur battery may improve energy density and life characteristics of the lithium-sulfur battery.

In an embodiment of the present disclosure, the tantalum pentafluoride may be included in an amount of 0.1 to 1 wt %, or 0.3 to 0.7 wt % based on the total weight of the electrolyte for the lithium-sulfur battery.

When the tantalum pentafluoride is included in the aforementioned range, it may be possible to further improve energy density and life characteristics of the lithium-sulfur battery.

In an embodiment of the present disclosure, the organic solvent may include acyclic ether and/or cyclic ether. Additionally, the acyclic ether and the cyclic ether may be included at a weight ratio of 0.5:9.5 to 5:5. When the acyclic ether and the cyclic ether are included at the aforementioned weight ratio, it may be more advantageous for the effect of the tantalum pentafluoride on the improved energy density and life characteristics of the lithium-sulfur battery.

The acyclic ether may include at least one selected from the group consisting of dimethylether, diethylether, dipropylether, methylethylether, methylpropylether, ethylpropylether, dimethoxyethane, diethoxyethane, ethyleneglycolethylmethylether, diethyleneglycoldimethylether, diethyleneglycoldiethylether, diethyleneglycol methylethylether, triethyleneglycoldimethylether, triethyleneglycoldiethylether, triethyleneglycolmethylethylether, tetraethyleneglycoldimethylether, tetraethyleneglycoldiethylether, tetraethyleneglycolmethylethylether, polyethyleneglycoldimethylether, polyethylene glycol diethyl ether, and polyethylene glycol methylethyl ether.

The cyclic ether may include at least one selected from the group consisting of 1,3-dioxolane, 4,5-dimethyl-dioxolane, 4,5-diethyl-dioxolane, 4-methyl-1,3-dioxolane, 4-ethyl-1,3-dioxolane, tetrahydrofuran, 2-methyltetrahydrofuran, 2,5-dimethyltetrahydrofuran, 2,5-dimethoxytetrahydrofuran, 2-ethoxytetrahydrofuran, 2-methyl-1,3-dioxolane, 2-vinyl-1,3-dioxolane, 2,2-dimethyl-1,3-dioxolane, 2-methoxy-1,3-dioxolane, 2-ethyl-2-methyl-1,3-dioxolane, tetrahydropyran, 1,4-dioxane, 1,2-dimethoxy benzene, 1,3-dimethoxy benzene, 1,4-dimethoxy benzene and isosorbide dimethyl ether, furan, 2-methyl furan, 3-methyl furan, 2-ethyl furan, 2-butyl furan, 2,3-dimethylfuran, 2,4-dimethylfuran, 2,5-dimethyl furan, pyran, 2-methylpyran, 3-methylpyran, 4-methylpyran, benzofuran, 2-(2-nitrovinyl)furan, thiophene, 2-methylthiophene, 2-ethylthiophene, 2-propylthiophene, 2-butylthiophene, 2,3-dimethylthiophene and 2,4-dimethylthiophene and 2,5-dimethylthiophene.

In an embodiment of the present disclosure, the lithium salt may include, without limitation, any compound that provides lithium ions commonly used in lithium-sulfur batteries. For example, the lithium salt may include at least one selected from the group consisting of LiFSI, LiTFSI, LiPF₆, LiClO₄, LiAsF₆, LiBF₄, LiSbF₆, LiAl0₄, LiAlCl₄, LiCF₃SO₃, LiC₄F₉SO₃, LiN(C₂F₅SO₃)₂, LiN(C₂F₅SO₂)₂, LiN(CF₃SO₂)₂, LiCl, LiI, and LiB(C₂O₄)₂.

The lithium salt is preferably used at the concentration in a range between 0.1M and 2.0M. When the concentration of the lithium salt is included in the aforementioned range, the electrolyte may have optimum conductivity and viscosity and exhibit outstanding electrolyte performance, contributing to the effective movement of lithium ions.

In an embodiment of the present disclosure, the additive may include a nitrate-based compound, and the nitrate-based compound may include at least one selected from the group consisting of lithium nitrate (LiNO₃) potassium nitrate (KNO₃), cesium nitrate (CsNO₃), magnesium nitrate (Mg(NO₃)₂), barium nitrate (Ba(NO₃)₂), potassium nitrite (KNO₂) and cesium nitrite (CsNO₂). In this instance, the additive may be included in an amount of 0.1 wt % to 10 wt % based on the total weight of the electrolyte. When the additive includes the nitrate-based compound, the energy density and life characteristics of the lithium-sulfur battery may be further improved.

In addition to the nitrate-based compound, the additive may further include at least one type of additive, for example, haloalkylenecarbonate-based compounds such as difluoroethylenecarbonate, pyridine, triethylphosphite, triethanolamine, cyclic ether, ethylene diamine, n-glyme, hexaphosphoric triamide, nitrobenzene derivatives, sulfur, quinone imine dyes, N-substituted oxazolidinone, N,N-substituted imidazolidine, ethylene glycol dialkyl ether, ammonium salts, pyrrole, 2-methoxy ethanol or aluminum trichloride, such as to improve life characteristics of the battery, suppress capacity fading of the battery and improve discharge capacity of the battery.

A second aspect of the present disclosure relates to a lithium-sulfur battery including the above-described electrolyte for the lithium-sulfur battery.

The lithium-sulfur battery according to an aspect of the present disclosure includes a positive electrode; a negative electrode; a separator between the positive electrode and the negative electrode; and an electrolyte, wherein the electrolyte is the above-described electrolyte for the lithium-sulfur battery according to embodiments of the present disclosure, the positive electrode includes a sulfur-carbon composite as a positive electrode active material, and the negative electrode includes lithium metal as a negative electrode active material. When the above-described electrolyte for the lithium-sulfur battery is used as the electrolyte, TaF₅ may react with the lithium metal of the negative electrode to form a protective layer. The protective layer will be described below.

In an embodiment of the present disclosure, the positive electrode may include a positive electrode current collector and a positive electrode active material layer on at least one surface of the positive electrode current collector. Additionally, the positive electrode may be a free-standing type including only the positive electrode active material layer.

In an embodiment of the present disclosure, the positive electrode current collector is not limited to a particular type and may include any positive electrode current collector that supports the positive electrode active material, and has high conductivity without causing any chemical change in the corresponding battery. For example, the positive electrode current collector may include copper, stainless steel, aluminum, nickel, titanium, palladium, sintered carbon, copper or stainless steel treated with carbon, nickel or silver on the surface, aluminum-cadmium alloys, etc.

The positive electrode current collector may have a microtextured or microhole textured surface to increase the bonding strength with the positive electrode active material, and may come in various forms, for example, a film, a sheet, a foil, a mesh, a net, a porous body, a foam, a nonwoven, etc.

In an embodiment of the present disclosure, the positive electrode active material layer may include the positive electrode active material and a binder polymer, and optionally, may further include a conductive material and an additive. The positive electrode active material includes the sulfur-carbon composite, and the sulfur-carbon composite includes a sulfur-based material supported on a porous carbon material. Here, the sulfur-based material may include sulfur and/or sulfide.

The sulfur-carbon composite may be included in an amount of 50 to 95 wt %, 60 to 95 wt % or 70 to 90 wt % based on 100 wt % of the positive electrode active material layer. When the sulfur-carbon composite is included in the aforementioned range, the positive electrode may cause sufficient electrochemical reaction, and the lithium-sulfur battery may have sufficient energy density.

The sulfur-based material may include, specifically, at least one selected from the group consisting of inorganic sulfur (S₈), Li₂Sn (n≥1), disulfide compounds such as 2,5-dimercapto-1,3,4-thiadiazole, 1,3,5-trithiocyanuic acid and organic sulfur compounds. Preferably, the sulfur-based material may include inorganic sulfur (Ss). The sulfur-based material may further include at least one type of additive selected from transition metal elements, Group IIIA elements, Group IVA elements, compounds of these elements and sulfur and alloys of these elements and sulfur. The transition metal elements may include Sc, Ti, V, Cr, Mn, Fe, Co, Ni, Cu, Zn, Y, Zr, Nb, Mo, Tc, Ru, Rh, Pd, Os, Ir, Pt, Au, Hg, etc., the Group IIIA elements may include Al, Ga, In, Tl, etc., and the Group IVA elements may include Ge, Sn, Pb, etc.

The porous carbon material may be a crystalline carbon material or an amorphous carbon material, and may be a conductive carbon. The porous carbon material provides skeletons for uniformly and stably immobilizing the sulfur-based material and compensates for low electrical conductivity of the sulfur-based material, to enhance electrochemical reaction.

The porous carbon material may be manufactured by carbonization of a variety of carbon-based precursors, and may include irregularities and/or pores therein. The average diameter of the pores may be from 1 nm to 200 nm, and the porosity may be from 10 vol % to 90 vol % of the total volume of the porous carbon material. When the average diameter of the pores satisfies the aforementioned range, the mechanical strength of the porous carbon material may be maintained.

The porous carbon material may include, without limitation, any porous carbon material commonly used in lithium-sulfur batteries, for example, spherical, rod-like, spiky, platy, tubular or bulky. Additionally, the porous carbon material may have high specific surface area. For example, the porous carbon material may include at least one selected from the group consisting of graphite, graphene, Super P, carbon black, Denka black, acetylene black, Ketjen black, channel black, furnace black, lamp black, thermal black, carbon fibers, carbon nanofibers, carbon nanotubes (SWCNT, MWCNT), carbon nanowires, carbon nanorings, carbon fabrics and fullerene (C60).

The porous carbon material may be an agglomerate of conductive carbon materials. Specifically, the porous carbon material may be formed by entanglement of linear conductive carbon material strands.

The sulfur-carbon composite may include the sulfur-based material in an amount of 60 wt % or more, 60 to 90 wt % or 70 to 90 wt % based on 100 wt % of the sulfur-carbon composite. When the sulfur-based material is included in the aforementioned range, the sulfur-based material and the porous carbon material are present in appropriate amounts, so the binder polymer may be used in a suitable amount for binding the sulfur-based material to the porous carbon material. Accordingly, there is no need to use an excessive amount of binder polymer that may cause a resistance rise, thereby improving the battery performance of the lithium-sulfur battery.

In the sulfur-carbon composite, the sulfur-based material may fill at least a portion of the internal space (for example, pores) of the porous carbon material, or along with or independent of this, may be located on the outer side in a manner of coating at least a portion of the surface of the carbon-based material. In a specific embodiment, the sulfur-based material may be present in an area of less than 100%, 1 to 95% or 60 to 90% of the surface of the porous carbon material. When the sulfur-based material is present in the aforementioned range, electrolyte wetting and electrical conductivity improves.

A method for manufacturing the sulfur-carbon composite may include any method commonly used in the art without limitation. For example, the sulfur-carbon composite may be manufactured by mixing sulfur with the porous carbon material and performing thermal treatment.

The sulfur-based material is converted to polysulfide during electrochemical reaction of the lithium-sulfur battery, and the polysulfide leaks into the electrolyte of the lithium-sulfur battery, and as a consequence, the positive electrode active material gradually reduces and the positive electrode structure collapses. However, according to aspects of the present disclosure, because the sulfur-based material is present inside the porous carbon material of 3-dimensional (3D) structure, the leakage of polysulfide produced by electrochemical reaction into the electrolyte may be prevented, and because the porous carbon material has the 3D structure, the collapse of the positive electrode structure induced by the polysulfide leakage may be prevented.

The binder polymer binds the positive electrode active material to the positive electrode current collector and interconnects the positive electrode active material to increase the bond strength, and may include any binder polymer well known in the art. For example, the binder polymer may include any one selected from the group consisting of a fluororesin-based binder including polyvinylidene fluoride (PVdF) or polytetrafluoroethylene (PTFE); a rubber-based binder including styrene butadiene rubber (SBR), acrylonitrile-butadiene rubber and styrene-isoprene rubber; a cellulose-based binder including carboxyl methyl cellulose (CMC), starch, hydroxypropyl cellulose and regenerated cellulose; a polyalcohol-based binder; a polyolefin-based binder including polyethylene and polypropylene; a polyimide-based binder; a polyester-based binder; a polyacrylic binder; and a silane-based binder or a mixture thereof or a copolymer thereof.

The binder polymer may be included in an amount of 0.5 to 30 wt % based on 100 wt % of the positive electrode active material layer. When the amount of the binder polymer satisfies the aforementioned range, the physical properties of the positive electrode improve, thereby preventing desorption of the active material and/or the conductive material in the positive electrode, and the ratio of the active material and/or the conductive material in the positive electrode may be appropriated controlled, thereby ensuring battery capacity.

The conductive material acts as movement paths of electrons from the current collector to the positive electrode active material by electrically connecting the electrolyte solution to the positive electrode active material, and may include any material having conductive properties without limitation. For example, the conductive material may include carbon black such as Super-P, Denka black, acetylene black, Ketjen black, channel black, furnace black, lamp black, thermal black, carbon black, etc.; carbon derivatives such as carbon nanotubes, graphene, fullerene, etc.; conductive fibers such as carbon fibers, metal fibers, etc; fluorocarbon, metal powders such as aluminum powder, nickel powder, etc.; or conductive polymers such as polyaniline, polythiophene, polyacetylene, polypyrrole, etc, used singly or in combination. The conductive material may be included in an amount of 0.01 to 30 wt %, 0.01 to 10 wt % or 0.01 to 5 wt % based on 100 wt % of the positive electrode active material layer. When the conductive material is included in the aforementioned range, it may be possible to improve the movement of electrons from the current collector to the positive electrode active material.

A method for forming the positive electrode active material layer on the current collector can be performed by known coating methods and is not particularly limited. For example, the coating method may include bar coating, screen coating, doctor blade, dip coating, reverse roll coating, direct roll coating, gravure coating or extrusion. The coating amount of the positive electrode active material layer on the current collector is not particularly limited and is adjusted in view of the target thickness of the positive electrode active material layer. Additionally, a known process required to manufacture the electrode, for example, a rolling or drying process may be performed before or after forming the positive electrode active material layer.

In an embodiment of the present disclosure, the negative electrode may be a free-standing type including only a negative electrode active material layer without a current collector. Additionally, the negative electrode may include a negative electrode current collector and a negative electrode active material layer on at least one surface of the negative electrode current collector.

In an embodiment of the present disclosure, the negative electrode current collector may include, without limitation, any negative electrode current collector that supports the negative electrode active material and has high conductivity without causing any chemical change in the corresponding battery. For example, the negative electrode current collector may include copper, stainless steel, aluminum, nickel, titanium, palladium, sintered carbon, copper or stainless steel treated with carbon, nickel or silver on the surface, aluminum-cadmium alloys, etc.

According to certain aspects, the negative electrode current collector can have a microtextured or microhole textured surface to increase the bonding strength with the negative electrode active material, and may come in various forms, for example, a film, a sheet, a foil, a mesh, a net, a porous body, a foam, a nonwoven, etc.

The negative electrode current collector may be 1 μm to 300 μm in thickness, but the thickness is not limited to a particular range and may be set to an appropriate range in view of the mechanical strength of the electrode, the productivity or the battery capacity.

In an embodiment of the present disclosure, the negative electrode active material layer includes lithium metal. Specifically, the negative electrode active material layer may include at least one of lithium metal or lithium alloy. Specifically, the lithium metal may be a single-phase lithium metal, for example, a lithium metal foil, and the lithium alloy may include an alloy of lithium and at least one of Si, Sn, C, Pt, Ir, Ni, Cu, Ti, Na, K Rb, Cs, Fr, Be, Mg, Ca, Sr, Sb, Pb, In, Zn, Ba, Ra, Ge or Al, but is not limited thereto.

When these materials are used as the negative electrode active material, the energy density may be higher than mixtures of lithium and other materials (for example, carbon and/or silicon) as the negative electrode active material. For example, when the mixtures of lithium and other materials are used as the negative electrode active material, the negative electrode active material is coated on the negative electrode current collector, and in this case, the use of the current collector reduces the amount of the negative electrode active material, and the energy density reduces.

The negative electrode active material layer may be 1 μm to 200 μm, 5 μm to 100 μm, 10 μm to 80 μm or 20 μm to 50 μm in thickness. When the thickness of the negative electrode active material layer is within the aforementioned range, it may be possible to suppress the growth of lithium dendrite and ensure sufficient battery capacity.

In an embodiment of the present disclosure, the negative electrode may be a current collector-free type including only the negative electrode active material layer, or may include the negative electrode active material layer on at least one surface of the negative electrode current collector.

The negative electrode current collector may include, without limitation, any current collector that is used in the technical field of lithium secondary batteries and lithium-sulfur batteries, and has high conductivity without causing side reaction in the battery. For example, the negative electrode current collector may include copper, stainless steel, aluminum, nickel, titanium, sintered carbon, copper or stainless steel treated with carbon, nickel, titanium or silver on the surface, aluminum-cadmium alloys, etc.

The negative electrode current collector is not limited to a particular thickness but may be 1 μm to 300 μm in thickness, and the thickness may be set to an appropriate range in view of the mechanical strength of the electrode, the productivity or the battery capacity.

In an embodiment of the present disclosure, the negative electrode includes the negative electrode active material layer and the protective layer on at least one of the negative electrode active material layer, and the protective layer may include LiF.

According to certain embodiments, the protective layer may be formed by reaction between TaF₅ included in the electrolyte and the lithium metal of the negative electrode. The protective layer may allow for uniform deposition of lithium over the negative electrode, thereby suppressing porousization in the negative electrode. Additionally, the lithium-sulfur battery including the negative electrode may have improved Coulombic efficiency and cycle life.

The protective layer may be formed on all or at least part of the negative electrode active material layer. For example, the protective layer may cover 90% or more of the surface of the negative electrode active material layer.

The protective layer may be formed with uniform thickness, and may be 5 to 500 nm in thickness. When the thickness of the protective layer is within the aforementioned range, it may be possible to prevent an excessive rise in resistance of the negative electrode, properly suppress porousization in the negative electrode and suppress dendrite growth on the negative electrode surface.

In an embodiment of the present disclosure, the separator may include a porous polymer substrate, or may include a porous polymer substrate and a porous coating layer on at least one surface of the porous polymer substrate.

The separator separates the negative electrode from the positive electrode and provides pathways for travel of lithium ions, and is not limited to a particular type and may include any type of separator commonly used in lithium-sulfur batteries, and in particular, preferably having low resistance to the movement of electrolyte ions and high ability to absorb the electrolyte.

The porous substrate is not limited to a particular material in the present disclosure and may include any porous substrate commonly used in electrochemical devices. For example, the porous substrate may include at least one type of material selected from the group consisting of polyolefin such as polyethylene, polypropylene, etc., polyester such as polyethyleneterephthalate, polybutyleneterephthalate, etc., polyamide, polyacetal, polycarbonate, polyimide, polyetheretherketone, polyethersulfone, polyphenyleneoxide, polyphenylenesulfide, polyethylenenaphthalate, polytetrafluoroethylene, polyvinylidene fluoride, polyvinyl chloride, polyacrylonitrile, cellulose, nylon, poly(p-phenylene benzobisoxazole) and polyarylate.

The porous substrate is not limited to a particular thickness, but may be 1 to 100 μm, preferably 5 to 50 μm in thickness. Although the thickness range of the porous substrate is not limited to the aforementioned range, when the thickness is too small below the above-described lower limit, the mechanical properties may decrease and the separator may be easily damaged while the battery is in use.

The average pore diameter and porosity of the porous substrate are not limited to particular ranges but may be 0.001 to 50 μm and 10 to 95 vol %, respectively.

In an embodiment of the present disclosure, the inorganic particles and the binder included in the porous coating layer are not limited to particular types and may include those commonly used in porous coating layers of separators, and a manufacturing method is not particularly limited.

In the lithium-sulfur battery according to an embodiment of the present disclosure, the electrolyte for the lithium-sulfur battery may be included in an amount of 300 wt % or less based on 100 wt % of the sulfur-based material. Specifically, the amount (E) of the electrolyte for the lithium-sulfur battery and the amount (S) of the sulfur-based material may satisfy the following Equation.

$$( E / S ) \times 100 \leq 300 ( \% ) \qquad Equation$$

When the lithium-sulfur battery includes the electrolyte in a large amount, the total volume of the lithium-sulfur battery increases or the amount of the positive electrode active material reduces, so the energy density of the lithium-sulfur battery reduces. Accordingly, to improve the energy density of the lithium-sulfur battery, it may be necessary to reduce the amount of the electrolyte and increase the amount of the positive electrode active material. However, the existing lithium-sulfur batteries typically fail to operate when the amount of electrolytes is small.

The lithium-sulfur battery according to aspects of the present disclosure may operate well in low electrolyte condition including 300 wt % or less of the electrolyte based on 100 wt % of the sulfur-based material.

Hereinafter, aspects of the present disclosure will be described in more detail through examples, but the following examples are provided to describe the present disclosure by way of illustration, and the scope of the present disclosure is not limited thereto.

### Example 1

### Preparation of Electrolyte for Lithium-Sulfur Battery

Dimethylfuran (2MeF) and dimethylether (DME) were mixed at a weight ratio of 2:8 and 0.75M of LiFSI was added to prepare a mixed solution. Subsequently, LiNO₃ and TaF₅ were added to the mixed solution to prepare an electrolyte. In this instance, LiNO₃ was present in an amount of 5 wt %, and TaF₅ was present in an amount of 0.1 wt % based on the total weight of the electrolyte.

### Manufacture of Positive Electrode

Sulfur (S₈) and multi-walled carbon nanotubes (MWCNT) were uniformly mixed at a weight ratio of 7:3. Subsequently, thermal treatment was performed in an oven of 150° C. for 30 minutes to load sulfur into carbon to produce a sulfur-carbon composite.

The obtained sulfur-carbon composite and polyacrlic acid as a binder polymer were added to water and mixed together to prepare a positive electrode slurry. In this instance, a weight ratio of the sulfur-carbon composite to the binder polymer was 96:4.

The slurry was coated on a 20 μm thick aluminum foil using a Mathis coater, dried at 50° C. for 24 hours, then rolled to manufacture a positive electrode. In this instance, the loading of the slurry was 3.3 mAh/cm², and in the rolling process, the porosity was 72 vol %.

### Manufacture of Lithium-Sulfur Battery

For a negative electrode, a 60 μm thick lithium metal foil (Ganfeng) was prepared.

The as-prepared positive and negative electrodes were placed with a polyethylene separator having a thickness 16 μm and a porosity of 46 vol % interposed between them, and 270 wt % of electrolyte was injected based on the weight of sulfur to manufacture a lithium-sulfur battery.

### Example 2

A lithium-sulfur battery was manufactured by the same method as Example 1 except that TaF₅ was added in an amount of 0.5 wt % based on the total weight of the electrolyte.

### Example 3

A lithium-sulfur battery was manufactured by the same method as Example 1 except that TaF₅ was added in an amount of 1 wt % based on the total weight of the electrolyte.

### Comparative Example 1

A lithium-sulfur battery was manufactured by the same method as Example 1 except that TaF₅ was not added.

### Comparative Example 2

A lithium-sulfur battery was manufactured by the same method as Example 1 except that TaF₅ was added in an amount of 1.2 wt % based on the total weight of the electrolyte.

### Comparative Example 3

A lithium-sulfur battery was manufactured by the same method as Example 1 except that instead of TaF₅, AgF was added in an amount of 0.5 wt % based on the total weight of the electrolyte.

### Comparative Example 4

A lithium-sulfur battery was manufactured by the same method as Example 1 except that instead of TaF₅, AlF₃ was added in an amount of 0.5 wt % based on the total weight of the electrolyte.

### Comparative Example 5

### Manufacture of Positive Electrode

LiNi_{0.8}Co_{0.1}Mn_{0.1}O₂, Denka black and styrene butadiene rubber/carboxymethyl cellulose (SBR:CMC=7:3 weight ratio) were added to a solvent at a weight ratio of 96:2:2 and mixed together to prepare a positive electrode slurry. The slurry was coated on a 20 μm thick aluminum foil using a Mathis coater, dried at 50° C. for 24 hours, then rolled to manufacture a positive electrode. In this instance, the loading of the slurry was 3.3 mAh/cm², and in the rolling process, the porosity was 30 vol %.

### Preparation of Lithium Ion Battery

A lithium ion battery was prepared by the same method as Example 1 except that the as-prepared positive electrode was used and the electrolyte did not include TaF₅.

### Comparative Example 6

A lithium ion battery was prepared by the same method as Comparative Example 5 except that TaF₅ was included in an amount of 0.5 wt % based on the total weight of the electrolyte.

### Experimental Example 1

A pouch cell was fabricated using each of the lithium-sulfur batteries prepared in Examples 1 to 3 and Comparative Examples 1 to 6, and were subject to a stabilization process by charging and discharging with a constant current of 0.1C at 25° C. 3 times, charging and discharging at 0.2C 3 times, then charging at 0.2C and discharging at 0.3C to measure life characteristics. In this instance, the lower limit of the discharge was set to 1.8V, the upper limit of the charge was set to 2.5V, and energy density was calculated based on the third cycle of 0.1C charge and discharge. Additionally, the number of cycles to 80% of the first capacity after 0.3C discharge was calculated as the life cycle of the corresponding electrolyte.

The following TABLE 1 summarizes the calculated energy density and life cycle.

TABLE 1

| | Capacity | Energy density | Life |
|---|---|---|---|
| | (mAh/g) | (Wh/kg) | (cycle) |
| Example 1 | 1165 | 396 | 120 |
| Example 2 | 1180 | 401 | 178 |
| Example 3 | 1168 | 397 | 150 |
| Comparative | 1168 | 397 | 88 |
| Example 1 | | | |
| Comparative | 1163 | 395 | 69 |
| Example 2 | | | |
| Comparative | — | — | 52 |
| Example 3 | | | |
| Comparative | — | — | 86 |
| Example 4 | | | |
| Comparative | — | — | 96 |
| Example 5 | | | |
| Comparative | — | — | 97 |
| Example 6 | | | |

It was confirmed that the lithium-sulfur batteries according to Example 1 to Example 3 including TaF₅ in an amount of 0.1 to 1.0 wt % based on the total weight of the electrolyte had sufficient capacity over 120 cycles or more. In contrast, it was confirmed that Comparative Example 1 without TaF₅ and Comparative Example 2 including a very large amount of TaF₅ had much poorer life characteristics than Example 1 to Example 3.

Additionally, it was confirmed that Comparative Example 3 and Comparative Example 4 including the additive other than TaF₅ also had much poorer life characteristics than Example 1 to Example 3.

On the other side, when comparing the lithium ion battery of Comparative Example 5 without TaF₅ with the lithium ion battery of Comparative Example 6 including TaF₅ in an amount of 0.5 wt % based on the total weight of the electrolyte, it was confirmed that there was no or little change in life characteristics of the lithium ion battery depending on the presence or absence of TaF₅. In contrast, when comparing the lithium-sulfur battery of Comparative Example 1 without TaF₅ with the lithium-sulfur battery of Example 2 including TaF₅ in an amount of 0.5 wt % based on the total weight of the electrolyte, it was confirmed that there was a remarkable improvement in life characteristics of the lithium-sulfur battery depending on the presence or absence of TaF₅.

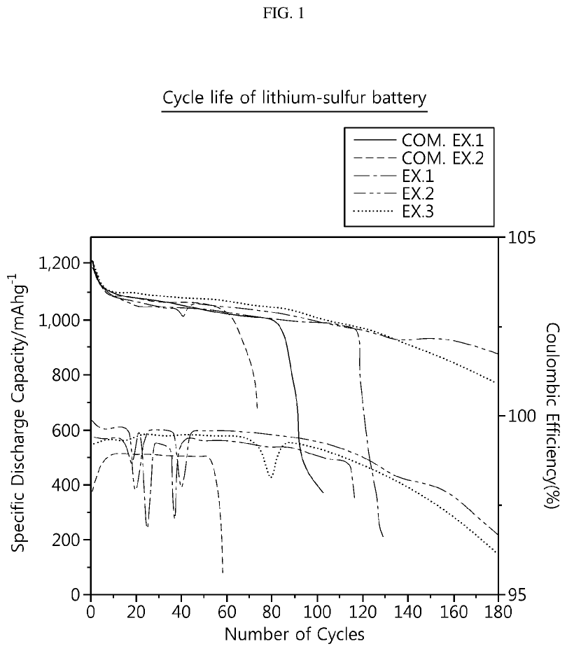

FIG. 1 shows Coulombic efficiency and capacity vs cycle life in the lithium-sulfur batteries of Example 1 to Example 3 and Comparative Example 1 and Comparative Example 2 according to the present disclosure. It was confirmed that Example 1 to Example 3 kept Coulombic efficiency and capacity constant over cycles, but the lithium-sulfur batteries of Comparative Example 1 and Comparative Example 2 had significant reductions in Coulombic efficiency and capacity. In particular, the amount of TaF₅ in Comparative Example 2 was higher by 0.2 wt % than Example 3, and there was a difference in Coulombic efficiency and capacity between them, so it was confirmed that the range of amounts of TaF₅ according to aspects of the present disclosure has criticality.

Although the present disclosure has been hereinabove described with a limited number of embodiments and drawings, the present disclosure is not limited thereto and a variety of changes and modifications may be made thereto by those skilled in the art within the technical aspect of the present disclosure and the scope of the appended claims and their equivalents.

What is claimed is:

1. An electrolyte for a lithium-sulfur battery comprising:
an organic solvent; a lithium salt; and an additive,
wherein the additive includes tantalum pentafluoride (TaF₅).

2. The electrolyte for the lithium-sulfur battery according to claim 1, wherein the tantalum pentafluoride is included in an amount of 0.1 to 1 wt % based on a total weight of the electrolyte for the lithium-sulfur battery.

3. The electrolyte for the lithium-sulfur battery according to claim 1, wherein the tantalum pentafluoride is included in an amount of 0.3 to 0.7 wt % based on a total weight of the electrolyte for the lithium-sulfur battery.

4. The electrolyte for the lithium-sulfur battery according to claim 1, wherein the organic solvent includes an acyclic ether or a cyclic ether.

5. The electrolyte for the lithium-sulfur battery according to claim 1, wherein the lithium salt includes at least one selected from the group consisting of LiFSI, LiTFSI, LiPF₆, LiClO₄, LiAsF₆, LiBF₄, LiSbF₆, LiALO₄, LiAlCl₄, LiCF₃SO₃, LiC₄F₉SO₃, LiN(C₂F₅SO₃)₂, LiN(C₂F₅SO₂)₂, LiN(CF₃SO₂)₂, LiCl, LiI, and LiB(C₂O₄)₂.

6. The electrolyte for the lithium-sulfur battery according to claim 1, wherein the additive includes at least one selected from the group consisting of lithium nitrate (LiNO₃) potassium nitrate (KNO₃), cesium nitrate (CsNO₃), magnesium nitrate (Mg(NO₃)₂), barium nitrate (Ba(NO₃)₂), potassium nitrite (KNO₂) and cesium nitrite (CsNO₂).

7. A lithium-sulfur battery comprising:
a positive electrode; a negative electrode; a separator between the positive electrode and the negative electrode; and the electrolyte according to claim 1,
wherein the positive electrode includes a sulfur-carbon composite as a positive electrode active material, and
wherein the negative electrode includes a lithium metal as a negative electrode active material.

8. The lithium-sulfur battery according to claim 7, wherein the sulfur-carbon composite includes a sulfur-based material supported on a porous carbon material, and
wherein the electrolyte is included in an amount of 300 wt % or less based on 100 wt % of the sulfur-based material.

9. The lithium-sulfur battery according to claim 7, wherein the sulfur-carbon composite includes a sulfur-based material supported on a porous carbon material, and
wherein the sulfur-based material is included in an amount of 60 wt % or more based on 100 wt % of the sulfur-carbon composite.

10. The lithium-sulfur battery according to claim 7, wherein the negative electrode includes a negative electrode active material layer and a protective layer on at least one surface of the negative electrode active material layer, and the protective layer includes LiF.
